(19) United States
(12) Patent Application Publication
(10) Pub. No.: US 2026/0329835 A1
(43) Pub. Date: Oct. 22, 2026

(54) SYSTEM AND METHOD FOR DATA INDEXING MECHANISM IN CLOUD-BASED COMPUTING ENVIRONMENT

(71) Applicant: GE DIGITAL HOLDINGS LLC, Cambridge, MA (US)

(72) Inventors: Tigran ANDJELIC, Cambridge (GB); Pavel BUDKA, Ostrava (CZ); Manuel WEINDORF, Weyher (DE)

(21) Appl. No.: 19/183,018

(22) Filed: Apr. 18, 2025

(51) Int. Cl. G06F 16/22

(52) U.S. Cl. CPC G06F 16/2246; G06F 16/2272

(57) ABSTRACT

A data store contains records including relational versioned data and logical primary keys. A data indexing platform may maintain a series of head version nodes linked to the records, and each head version node is a directed acyclic graph forming a multi-headed B+ index hierarchy. The hierarchy includes original and shared child version nodes and ends in original and shared records. Moreover, parent version nodes in the hierarchy are linked to their child version nodes via the logical primary keys. The platform determines an update to a previous record in the data store and inserts a new record into the data store based on the update. The platform inserts a new child version node into a new hierarchy for the new record. A new head version node, representing the new record and new hierarchy of child version nodes, is then inserted into the series of head version nodes.

### BACKGROUND

Several challenges arise in the context of enterprise scale geospatial data management. In particular, for utility organizations, such as telecommunications, water, gas, and electricity utilities, the planning and management of thousands of concurrent network changes poses a difficult and complex task with two key objectives. First, each set of concurrent network changes should be evaluated against the entire network on its own merit. The state of the network has to be maintained as of the time the change set was created.

Second, network change sets should be kept in isolation until they are approved for publishing (at which point they are aligned with any pre-introduced changes on the main network). Note that a typical requirement for a versioned data store is to persist tens of thousands of hierarchical data versions.

Traditionally, replication and data extracts are in separate database instances or schemas to then be worked on for planning and design purposes. This approach has a number of restrictions and typically does not provide concurrent access because the extracts are typically locked during the time period they are worked on. In another approach, version information may be managed using an additional attribute on tables and records as a form of data version stamping. This is an approach that can address objectives of versioning in an application, but it has significant drawbacks due to schema complexity from both persistence and transactional perspective. Version stamping might be implemented in conjunction with dynamic and materialized views that represent an individual version perspective for access. This approach works well for some limited scenarios but has significant drawbacks with performance and volumes of duplicated data for the enterprise needs of large utilities.

It would be desirable to automatically provide a data indexing mechanism in an automatic, accurate, and efficient manner.

### SUMMARY

According to some embodiments, a relational information data store contains records including relational versioned data and logical primary keys. A data indexing platform may maintain a series of head version nodes linked to the records, and each head version node is a directed acyclic graph forming a multi-headed B+ index hierarchy. The hierarchy includes original and shared child version nodes and ends in original and shared records. Moreover, parent version nodes in the hierarchy are linked to their child version nodes via the logical primary keys. The platform determines an update to a previous record in the data store and inserts a new record into the relational information data store. The platform inserts a new child version node into a new hierarchy for the new record such that the new hierarchy includes original, shared, and new records. A new head version node, representing the new record and new hierarchy of child version nodes, is then inserted into the series of head version nodes.

Some embodiments comprise: means for accessing, by a computer processor of a data indexing platform, a relational information data store that contains records associated with relational versioned data and logical primary keys; means for maintaining a series of head version nodes linked to records of the relational information data store, each head version node being associated with a directed acyclic graph forming a multi-headed B+ index hierarchy of child version nodes, including original and shared child version nodes, wherein the hierarchies end in original and shared records, and parent version nodes in the hierarchy are linked to their child version nodes via the logical primary keys; means for determining, via a cloud-based computing environment, an update to a previous record in the relational information data store; means for inserting a new record into the relational information data store based on the update; means for inserting a new child version node into a new hierarchy of child version nodes for the new record such that the new hierarchy of child version nodes includes original, shared, and new child version nodes; and means for inserting a new head version node, representing the new record and new hierarchy of child version nodes, into the series of head version nodes.

Some technical advantages of some embodiments disclosed herein are improved systems and methods to a data indexing mechanism in an automatic, accurate, and efficient manner.

### BRIEF DESCRIPTION OF THE DRAWINGS

FIG. 1 is a high-level architecture for a data indexing system according to some embodiments.

FIG. 2 is a data indexing method in accordance with some embodiments.

FIG. 3 through 6 are a multi-headed B+ tree example according to some embodiments.

FIG. 7 is a block diagram of a platform according to some embodiments.

FIG. 8 represents relational data tables in accordance with some embodiments.

FIG. 9 is an operator or administrator display in accordance with some embodiments.

FIG. 10 is another implementation according to some embodiments.

### DETAILED DESCRIPTION

In the following description, specific details are set forth in order to provide a thorough understanding of the various example embodiments. It should be appreciated that various modifications to the embodiments will be readily apparent to those skilled in the art, and the generic principles defined herein may be applied to other embodiments and applications without departing from the spirit and scope of the disclosure. Moreover, in the following description, numerous details are set forth for the purpose of explanation. However, one of ordinary skill in the art should understand that embodiments may be practiced without the use of these specific details. In other instances, well-known structures and processes are not shown or described in order not to obscure the description with unnecessary detail. Thus, the present disclosure is not intended to be limited to the embodiments shown but is to be accorded the widest scope consistent with the principles and features disclosed herein.

Embodiments described herein may provide sophisticated data versioning within relational database, and each version may capture the context of the entire data set at a specific point in time. The key implementation component is a graph structure with multiple root nodes that is used as an indexing scheme to navigate each named version. As such, this graph is a key for version data and version life cycle management.

This graph is referred to herein as a multi-headed B+ tree. In general, a B+ tree is an m-ary tree with a variable number of children per node. A B+ tree consists of a root, internal nodes, and leaves (the root may be a leaf or node with two or more children). A B+ tree can be considered as a B-tree in which each node contains only keys (not key-value pairs) and additional levels are added at the bottom with linked leaves. A benefit of a B+ tree is in storing data for efficient retrieval in a block-oriented storage context. Unlike binary search trees, B+ trees have high fanout (number of pointers to child nodes in a node), which reduces the number of Input Output (“IO”) operations required to find an element in the tree. The multi-headed B+ tree may be implemented as a directed acyclic graph where tree nodes only store the links to their children (not to their parents). The child and corresponding parent relationship is maintained via the state of the tree traversing strategy (breadth and depth-first search). This pattern ensures that nodes and records do not maintain related version lists as such information is implicitly within the graph. Therefore, redundancy is eliminated with equal efficiency for concurrent data access across individual versions.

The versioning is implemented in such a way that the entire version index is managed and maintained separate from the regular user data tables. Therefore, the version management can be applied to any user data model. The logic of version management is implemented on the database client while the persistence of the underlying B+ tree and the related user data is maintained in a relational database. Note that virtual machine logic might be embedded within a database kernel.

All changes are recorded as record level differences (no duplicate index tree nodes or records are stored), minimizing the overhead in storing versions and streamlining the lookup of versioned records. All data records are basically immutable and changes in the data (inserts, updates and deletions) are modelled as a clone and update function. When a change is introduced via create, insert, update, or delete functions, the affected records and index tree nodes get cloned, and the clone is updated instead. There are corresponding index node hierarchies built for the differences, and a new version is based on a rearranged index tree. The previous version is still accessible via the previous entry point to the index tree. Shared objects (e.g., index nodes and records) between versions are not duplicated.

This enables all versions of a record that ever existed to be maintained and accessed if needed. Furthermore, it provides transactional isolation of concurrent long-lasting transactions across versions that is mandatory for typical long-lasting planning and design processes. As such, the approach avoids locking restrictions for concurrent transactions, as opposed to check-in/check-out approaches, when working on the same version. Embodiments may apply an optimistic non-locking strategy, because changes are performed on cloned versions that get resolved when changes have to be aligned with the parent version. At this point in the lifecycle, parent locking and conflict resolution is carried out. To support conflict handling while changes between versions are aligned, a difference detection and conflict resolution strategy may be implemented. On top of the tree-based version index for individual tables/data collections, embodiments may provide a hierarchical order of the individual versions across the entire dataset (set of user data tables) alongside with facilities that manage and maintain this version hierarchy.

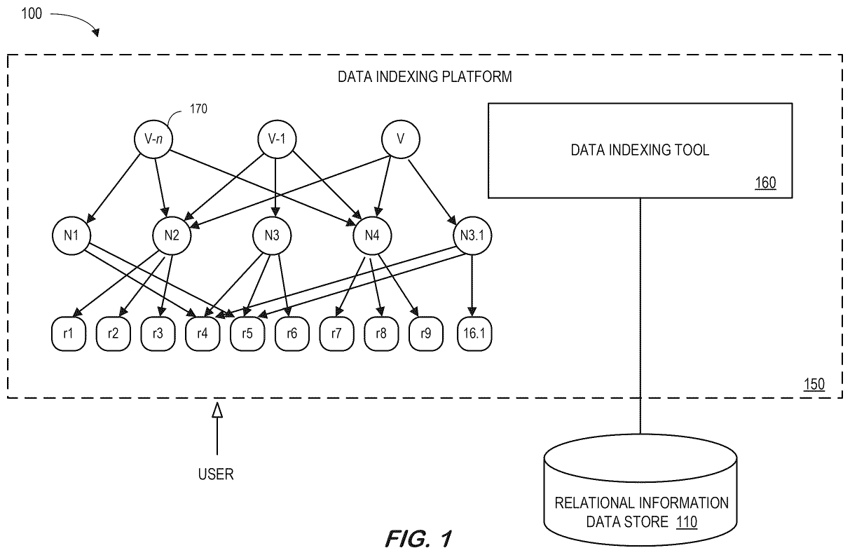

FIG. 1 is a high-level block diagram of a system 100 to provide data indexing according to some embodiments. The system 100 may include a data indexing platform 150 coupled to a relational information data store 110. The relational information data store 110 may, according to some embodiments, store information about system versions. Information from the relational information data store 110 may be provided to a data indexing tool 160. The data indexing tool 160 may automatically maintain version hierarchies 170. As used herein, the term “automatically” may refer to, for example, actions that can be performed with little or no human intervention.

As used herein, devices, including those associated with the system 100 and any other device described herein, may exchange information via any communication network which may be one or more of a Local Area Network (“LAN”), a Metropolitan Area Network (“MAN”), a Wide Area Network (“WAN”), a proprietary network, a Public Switched Telephone Network (“PSTN”), a Wireless Application Protocol (“WAP”) network, a Bluetooth network, a wireless LAN network, and/or an Internet Protocol (“IP”) network such as the Internet, an intranet, or an extranet. Note that any devices described herein may communicate via one or more such communication networks.

The system 100 may store information into and/or retrieve information from various data stores, such as the relational information data store 110. The various data stores may be locally stored or reside remote from other components. Although a single data indexing platform 150 is shown in FIG. 1, any number of such devices may be included. Moreover, various devices described herein might be combined according to embodiments of the present invention. For example, in some embodiments, the data indexing platform 150 and the relational information data store 110 might comprise a single apparatus. The functions of the system 100 may be performed by a constellation of networked apparatuses, in a distributed processing or cloud-based architecture. Such an approach may provide a scalable and elastic pool of shareable physical or virtual resources, pre-configured tools (e.g., data analytics and machine learning), and/or managed services (letting users focus on things other than maintaining infrastructure). Cloud platforms can let costs scale with usage and offer various redundancy options for services, including cross-region replication or failover systems.

A user may access the system 100 via one of the monitoring devices (e.g., a Personal Computer (“PC”), tablet, or smartphone) to view information about and/or manage adaptive controller and system information in accordance with any of the embodiments described herein. In some cases, an interactive graphical display interface may let a user define and/or adjust certain parameters (e.g., information mappings, version updates, search terms, etc.) and/or provide or receive automatically generated recommendations, alerts, or results from the system 100.

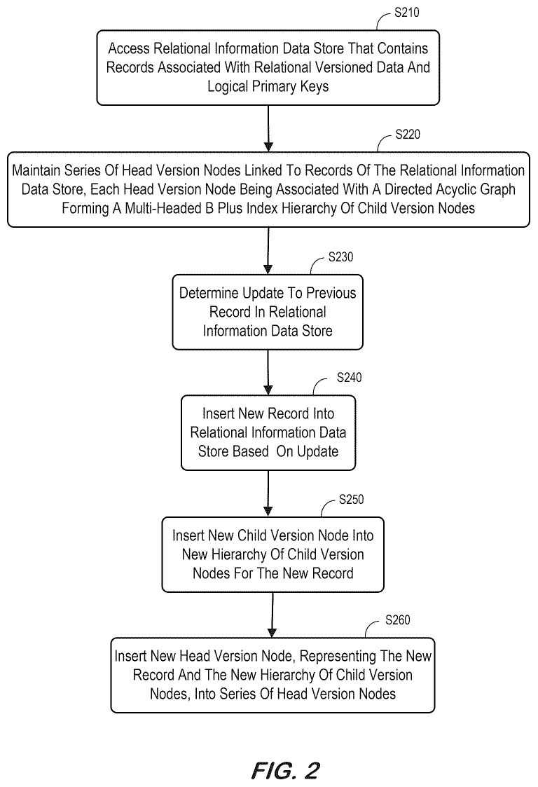

FIG. 2 is a method that might be associated with the system 100 of FIG. 1 in accordance with some embodiments. The flow charts described herein do not imply a fixed order to the steps, and embodiments of the present invention may be practiced in any order that is practicable. Note that any of the methods described herein may be performed by hardware, software, or any combination of these approaches. For example, a computer-readable storage medium may store thereon instructions that when executed by a machine result in performance according to any of the embodiments described herein.

At S210, a computer processor of a data indexing platform may access a relational information data store. The relational information data store may, for example, contain records associated with relational versioned data and logical primary keys. The relational information data store may be associated with a geospatial database system (e.g., representing represents interlinked utility network models. In some embodiments, a logical primary key is a hidden physical primary key.

At S220, the system may maintain a series of root or head version nodes linked to records of the relational information data store. Each head version node is associated with a directed acyclic graph forming a multi-headed B+ index hierarchy of child version nodes (including original and shared child version nodes,). Moreover, the hierarchies end in original and shared records, and parent version nodes in the hierarchy are linked to their child version nodes via the logical primary keys.

At S230, via a cloud-based computing environment, an update to a previous record in the relational information data store is determined, and a new record is inserted into the relational information data store at S240. At S250, a new child version node is inserted into a new hierarchy of child version nodes for the new record (such that the new hierarchy of child version nodes includes original, shared, and new child version nodes). At S260, a new head version node, representing the new record and the new hierarchy of child version nodes, is inserted into the series of head version nodes. In this way, each version captures a context of the relational versioned data at a specific point in time.

According to some embodiments, the data indexing platform is also used to traverse and cache the multi-headed B+ index. Moreover, the data indexing platform records updates to the multi-headed B+ index as record level differences without storing duplicate nodes or records and is able to maintain and access all records of the multi-headed B+ index that ever existed. The data indexing platform may further provide a user with a versioned database view of the multi-headed B+ index via a set of tables and a tree of alternatives with epochs and checkpoints. Note that during a long transaction, duplication may happen only for persistent records (that is, a duplicated node is not duplicated again it is changed in situ). Therefore, the new root becomes persistent when the long transaction finishes (e.g., commits) and each new root represents a commit (epoch, persistent version) in the database.

In this way, embodiments may implement an indexing mechanism (a multi-headed B+ index tree) that efficiently persists versioned data as well as effectively enabling access to relational data of any version and within the context of that individual named version. This mechanism may be particularly suited to (but not necessarily limited to) geospatial database systems, such as those that support concurrent states of complex interlinked network models.

Embodiments may also manage enterprise scale, relational data sets in a way that lets any concurrent version of the master data be created and used at the same level of quality and functionality (with minimal duplication and redundancy). The versions may be the same in terms of structure, quality, and usability as the master data. Version management may be achieved via a specific way of indexing the data, any version can be selected and accessed as if it was the only version of the master data.

A versioned data store may need to persist tens of thousands of hierarchical data versions. Each individual version may interact with the data exclusively within its original state and only consider the changes made within the version. Despite a large number of individual versions, embodiments may provide for efficient physical persistence of the concurrent version deltas as well as efficient access to the data from corresponding applications. This approach enables a whole versioned data perspective for each individual version without duplication of unchanged data.

Transactional separation may be enabled across individual versions along with efficient management of conflicting (and non-conflicting) changes throughout the version hierarchy. As a consequence, transactional data access becomes linearly scalable in relation to version number. Additionally, embodiments may allow for a very efficient comparison of deltas across different versions in connection with the management of concurrent version lifecycles within hierarchical version sets. Within typical Geospatial Information Systems (“GIS”), embodiments may enable a number of unique applications particularly suited to (but not necessarily limited to) managing connected geospatial utility networks (e.g., an electrical power grid).

Several challenges arise in the context of enterprise scale geospatial data management and get addressed with the disclosed embodiments. In particular, for utility organizations the planning and management of thousands of concurrent network changes can pose a difficult and complex task with two key objectives. Namely: (1) each set of concurrent network changes has to be evaluated against the entire network on its own merit, and (2) network change sets have to be kept in isolation until they are approved for publishing.

Embodiments may enable both of these key objectives to be met in an efficient and effective way for versioning of geospatial data.

The versioning capabilities enable consistent addressing of the following typical business challenges:
Data synchronization between enterprise systems. A typical enterprise system landscape consists of several systems of record and truth of different scopes and coverage. Those systems usually have to exchange data in an organized, traceable, and consistent way, which can be achieved/solved by applying version comparisons and subsequent merge and post operations.
Data mobilization to support field workers/processes in offline mode. A mobile workforce needs up-to-date records from the master datasets and needs to update and collect data out in the field, even without network connectivity (offline). Therefore, consistent data extracts need to be created (a version of the master data) and handed over to the external/mobile workforce. To synchronize the changes and extensions made in the field, the data may be synchronized back to the master data while applying version managed data synchronization featured (merge and post operation).
Data maintenance over time. Note that planning and design work typically last for longer periods of time (days, months, or even years). Typical long-lasting design and planning processes cannot afford to block each other while maintaining the state of the data at a point in time and they need to be based on actual and consistent information. While utilizing concurrent versions, those processes can work on dedicated versions of the master data and periodically update the data via controlled merge and post operations.
Provision of alternatives for planning and decision-making processes to simulate different versions of a design.
Change detection and tracking over time.

Embodiments described herein are able to manage versions of an enterprise scale relational dataset. Those versions can be used (updated and extended) at the same quality and with the same functionality as the master data. Throughout the lifetime of a version, this version can consistently be updated by the base data, changes in the version are invisible to the master and all other versions until a user/process decides to post the changes up to the master. If a version is not needed anymore, it can either be dropped or synchronized back with the master. Those operations ensure consistency between several datasets, all derived from the source of truth (enterprise scale master dataset) and provide an organized and controlled way to manage differences and change (which is mandatory for long living enterprise scale data sets which act as the source of truth for many dependent business processes and systems).

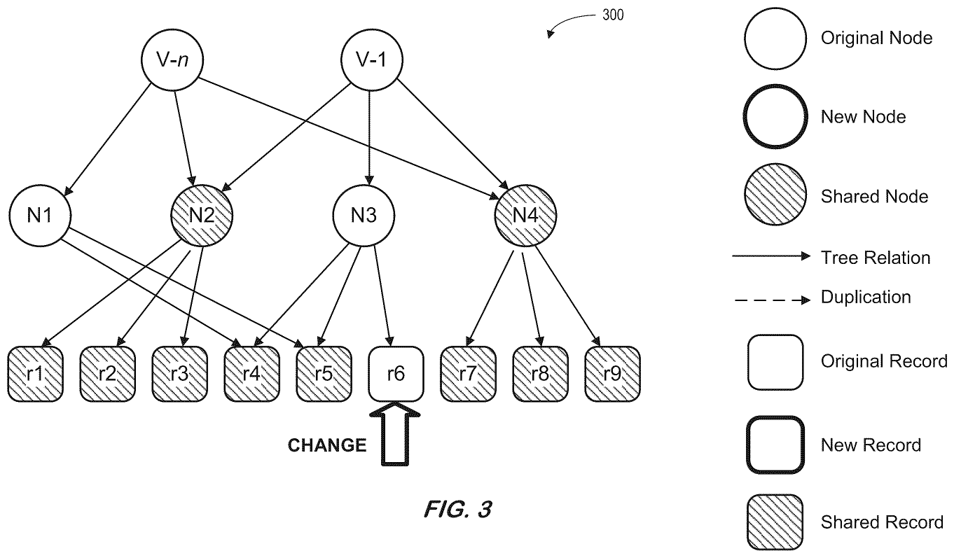

FIG. 3 through 6 are a multi-headed B+ tree example according to some embodiments. In particular, FIG. 3 shows an example 300 having two trees with the head nodes appearing on top. They represent versions V-n and V-1. Each version is represented by a head node which refers to records of the table. Nodes refer to their children and they are referring to them via the logical primary key of the table, enabling quick record lookup based on key (or a key range) as in a typical B+ tree index. A logical primary key of the table is the primary key from the user point of view.

Version V-n includes: shared records r4-r5 (through node N1), shared records r1-r2 (through shared node N2), and shared records r7-r9 (through shared node N4). Version V-1 includes: shared records r1-r3 (through hared node N2), shared records r4-r5 and record r6 (through node N3), and shared records r7-r9 (through shared node N4). Moreover, a change is detected in connection with record r6.

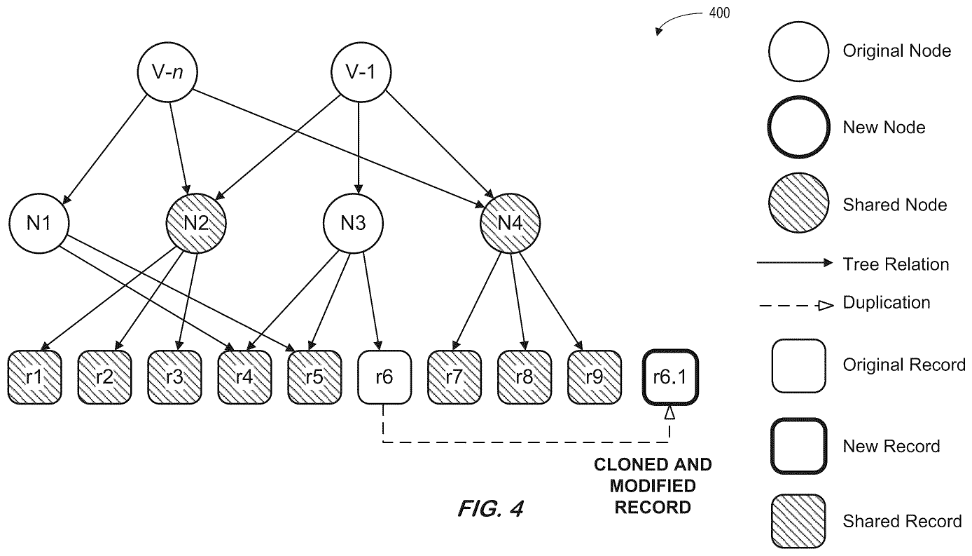

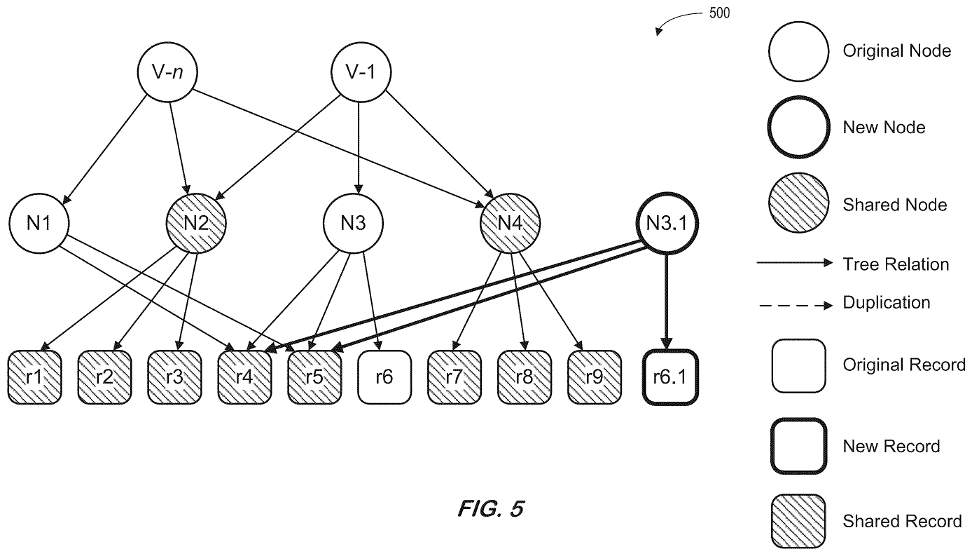

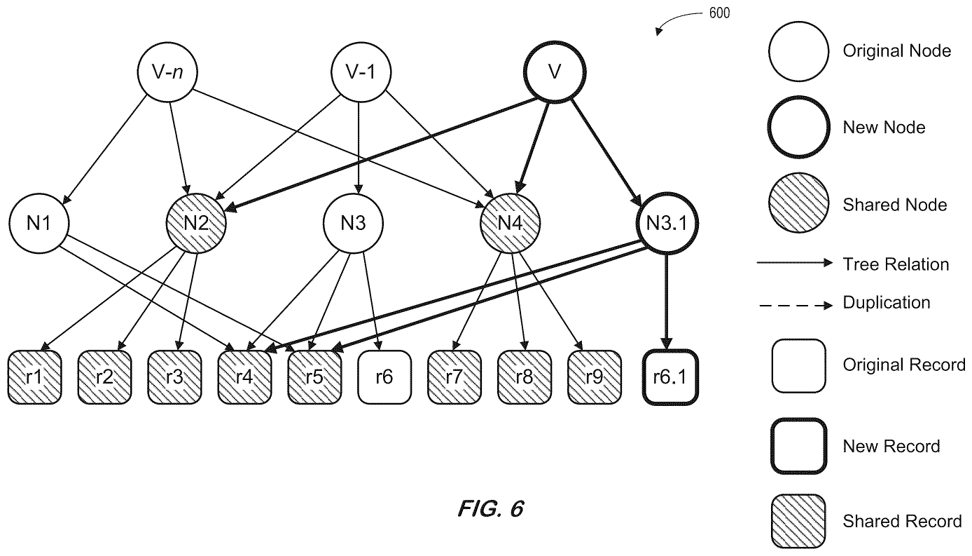

When a record in the table is updated, the original record remains unchanged and a new cloned and updated record is inserted instead. FIG. 4 shows an example 400 wherein the change in record r6 results in a new cloned and updated record r6.1 being created with a new value. Then the parent node of the record is updated to refer to the new record r6.1 rather than to the original record r6, but again the original node N3 remains unchanged and a new node N3.1 is inserted. This process is continued up the hierarchy. FIG. 5 shows an example 500 where a new node N3.1 (a cloned and modified version of node N3) is added to reference shared nodes r4 and r5 and the new record r6.1. The same needs to be repeated for it's parent nodes until a new head of the tree is inserted. Finally, FIG. 6 shows an example 600 where a new head node V is added referring to shared nodes N2 and N4 along with new node N3.1. The new head node V is an entry point to the new version of the table. It relates to all shared nodes and also the new node N3.1 and the new record r6.1.

This scheme shows immutable nature of the nodes. The original version of data was preserved and none of it (neither records nor nodes) was changed. This allows for efficient caching to reduce interaction with the server queries and thus improve performance. To make this concept even more efficient, the new nodes are mutable until the new version is committed (i.e., made persistent by running a database transaction on the server). Therefore, further changes to a new record before such a commit can be done in situ in the record and the same applies to nodes.

The scheme shows an update operation on the record and how the update is converted to an insert. An insert operation also means inserting a new record and “update” of the parent nodes so that the new record is referenced only by the new version. A delete operation is then only “update” of the parent nodes so that the original record is not referenced by new version. The table itself therefore consists of records necessary for all table's versions.

Because a versioned record update is actually a record insert, then after this the update there will be more records in the table with the same logical primary key. This is why the table may utilize a hidden physical primary key. This is the “real” primary key for the table and may be hidden from the user of the database. It is a “long serial” type and it is referred to from leaf nodes. Higher level nodes (index nodes) refer to child nodes via their identifier which is also a “long serial” type. Note that nodes may be implemented as records from specific database tables, and they are traversed (and also cached) on a client, but it is possible to move the whole multi-headed B+ tree index implementation to the database server. That is, the overall concept is agnostic about where (client or server) the traversing and B+ tree management is implemented.

As used herein, a “view” may refer to a set of tables whose versions are managed in synchronization. It may be important that all tables in the relational scheme are versioned in synchronization to ensure consistent data and relationships in all versions of the database.

As used herein, an “epoch” may refer to a single committed version which refer to heads of multi-headed B+ index trees for all of the tables in a view (e.g., an alterative version associated with a parent node). When a user commits changes, they become persistent in the database and available to other users. A rollback cancels the changes. An epoch may be an implementation concept which is hidden from the user but may be fundamental for providing checkpoints and alternatives that a user creates, manages, and uses to capture a desired version of the view and switch back to that version later. As used herein, a “checkpoint” may refer to an epoch with an assigned name. Therefore, a user can switch between these versions. Checkpoints may be created to serve as snapshots of the database.

As used herein, an “alternative” may refer to a list of epochs and checkpoints organized as tree. When a database is created, it has the top alternative. When an alternative is created it knows its parent alternative and also version of the parent alternative from which it was created (the epoch of the parent alternative). This enables data operations like merge, post, and align between an alternative and a parent.

In a typical business case where the database is used for asset management, there is a dedicated alternative which represents state of assets are they are in the field (current status of the reality), then there are other alternatives representing projects (e.g., planned work or work under construction). Alternatives in the database can also be used to capture alternative solutions for the same project. These can be evaluated and only one of them chosen (data from alternative representing this project will then be posted while others are removed).

Embodiments of the multi-headed B+ tree may implement a data merge down from a parent to a child alternative, with child alternative merges changes being done in the parent after the alternative was spawned from the parent. Post data merges may be implemented up from a child alternative to the parent (changes may be done in child after the alternative was spawn are posted to parent). Embodiments of the multi-headed B+ tree may also implement differencing to obtain differences between two versions of a view which consists of differences between the two versions of all tables of the view. This enables implementation of data operations like merge and post. Embodiments of the multi-headed B+ tree may also implement conflict resolution when an alternative is created then both the alternative and its parent alternative can be changed (and new epochs created). Therefore, the same record can be changed in both the alternative and its parent. This can cause a conflict when changes from a parent are merged to an alternative. Such a conflict is detected and can be handled either automatically in favor of the alternative, its parent, or the original (base) version or can be resolved by provided resolution script or interactively.

In a multi-headed B+ tree implementation, a majority of the data may be shared between versions of the database (checkpoints and alternatives) and system may only generate data to capture changes between versions. Implementations may provide a user with a versioned database view with set of tables and a tree of alternatives with epochs and checkpoints. The selected version of each table of the view reflects the current epoch of the current alternative. A user can create alternatives and checkpoints and create a new epoch in a current alternative by committing the changes. Implementations may also manage heads of the multi-headed B+ index tree of all tables in a view (e.g., by referring to a top B+ tree node in a table_root table).

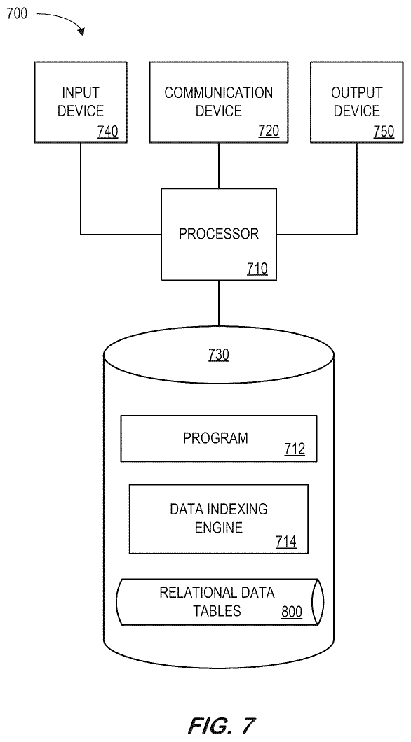

The embodiments described herein may be implemented using any number of different hardware configurations. For example, FIG. 7 is a block diagram of a data indexing platform 700 that may be, for example, associated with the system 100 of FIG. 1. The data indexing platform 700 comprises a processor 710, such as one or more commercially available Central Processing Units (“CPUs”) in the form of one-chip microprocessors, coupled to a communication device 720 configured to communicate via a communication network (not shown in FIG. 7). The communication device 720 may be used to communicate, for example, with one or more remote user platforms, operator or administrator devices, etc. The data indexing platform 700 further includes an input device 740 (e.g., a computer mouse and/or keyboard to input network changes) and/an output device 750 (e.g., a computer monitor to render a display, provide alerts, transmit recommendations, and/or create reports). According to some embodiments, a mobile device, monitoring physical system, and/or PC may be used to exchange information with the data indexing platform 700.

The processor 710 also communicates with a storage device 730. The storage device 730 may comprise any appropriate information storage device, including combinations of magnetic storage devices (e.g., a hard disk drive), optical storage devices, mobile telephones, and/or semiconductor memory devices. The storage device 730 stores a program 712 and/or a data indexing engine 714 for controlling the processor 710. The processor 710 performs instructions of the programs 712, 714, and thereby operates in accordance with any of the embodiments described herein. For example, the processor 710 may maintain a series of head version nodes linked to the records, and each head version node is a directed acyclic graph forming a multi-headed B+ index hierarchy. The hierarchy includes original and shared child version nodes and ends in original and shared records.

Moreover, parent version nodes in the hierarchy are linked by to their child version nodes via the logical primary keys. The processor 710 determines an update to a previous record in the data store and inserts a new record into a relational data store. The processor 710 inserts a new child version node into a new hierarchy such that the new hierarchy now includes original, shared, and new records. The processor 710 can then insert a new head version node, representing the new record and new hierarchy of child version nodes, into the series of head version nodes.

The programs 712, 714 may be stored in a compressed, uncompiled and/or encrypted format. The programs 712, 714 may furthermore include other program elements, such as an operating system, clipboard application, a database management system, and/or device drivers used by the processor 710 to interface with peripheral devices.

As used herein, information may be “received” by or “transmitted” to, for example: (i) the data indexing platform 700 from another device; or (ii) a software application or module within the data indexing platform 700 from another software application, module, or any other source.

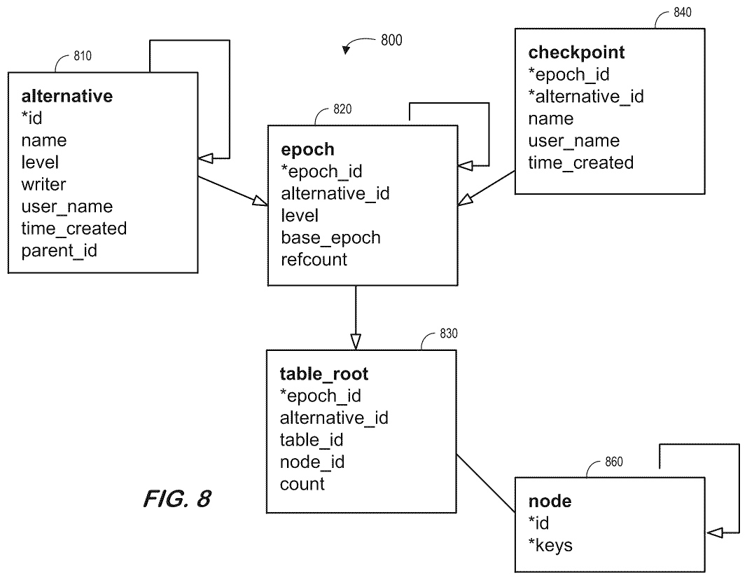

In some embodiments (such as the one shown in FIG. 7), the storage device 730 further stores relational data tables 800. An example of tables that may be used in connection with the platform 700 will now be described in detail with respect to FIG. 8. Note that the tables described herein are only examples, and additional and/or different information may be stored therein. Moreover, various tables might be split or combined in accordance with any of the embodiments described herein. Referring to FIG. 8, a simplified SQL data model of an implementation may include an alternative table 810, an epoch table 820, a table_root 830 (to manage heads of a multi-headed B+ index tree by a referring to a top node), a checkpoint table 840, 8 and a node table 860. Note that an epoch (one persistent version of the view) is a record in the epoch table 820. Alternatives may include a 1:N relationship (alternative tree) and a 1:N epoch (version list of the alternative). Moreover, an epoch has a 1:N references to table root nodes for all tables related to the epoch.

The following illustrates various additional embodiments of the invention. These do not constitute a definition of all possible embodiments, and those skilled in the art will understand that the present invention is applicable to many other embodiments. Further, although the following embodiments are briefly described for clarity, those skilled in the art will understand how to make any changes, if necessary, to the above-described apparatus and methods to accommodate these and other embodiments and applications.

Although specific hardware and data configurations have been described herein, note that any number of other configurations may be provided in accordance with embodiments of the present invention (e.g., some of the information associated with the databases described herein may be combined or stored in external systems). For example, although some embodiments are focused on utility assets, any of the embodiments described herein could be applied to other types of assets, such as computer networks, etc.

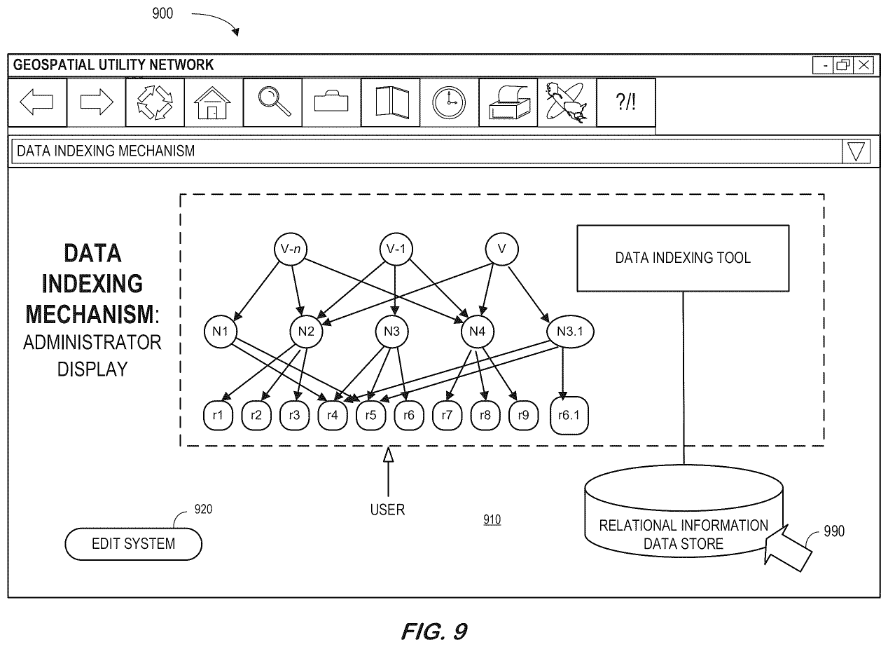

FIG. 9 is an indexing mechanism display 900 in accordance with some embodiments. The display 900 includes information about a data indexing platform 910 having a multi-headed B+ index tree. In particular, the display 900 might include graphical representation of elements in accordance with any of the embodiments described herein.

According to some embodiments, the display 900 is interactive and may be used by an administrator or operator to determine more detailed information (e.g., via selection of an “Edit System” icon 920 via a touchscreen or computer pointer 990), alter system mappings, adjust operation of the platform 910, etc.

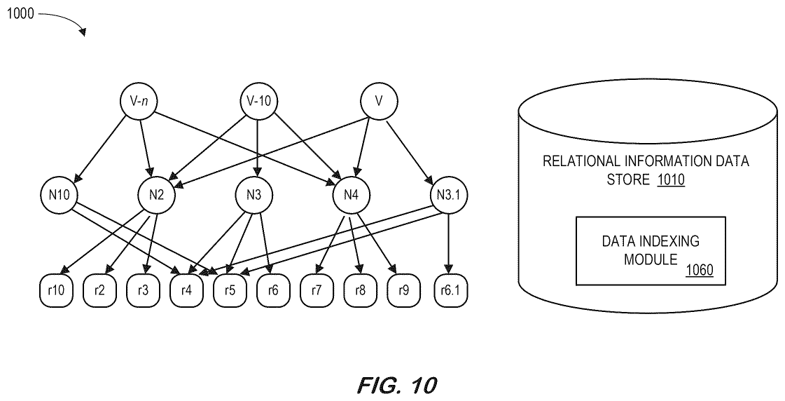

In some embodiments described herein, version nodes are traversed (and indexed) on a client. Note, however, that this function could be moved to a server. For example, FIG. 10 is another implementation 1000 according to some embodiments. In this case, a data indexing module 1060 is implemented within a relational data store 1010.

The present invention has been described in terms of several embodiments solely for the purpose of illustration. Persons skilled in the art will recognize from this description that the invention is not limited to the embodiments described but may be practiced with modifications and alterations limited only by the spirit and scope of the appended claims.

1. A data indexing system, comprising:
a geospatial database system data store containing records of relational versioned data and logical primary keys for interlinked electrical power grid network models;
a data indexing platform, coupled to the geospatial database system data store, including:
a computer processor, and
a computer memory storing instructions that, when executed by the computer processor, cause the data indexing platform to:
maintain a series of head version nodes linked to records of the geospatial database system data store, each head version node being associated with a directed acyclic graph forming a multi-headed B+ index hierarchy of child version nodes, including original and shared child version nodes, wherein the hierarchies end in original and shared records, and parent version nodes in the hierarchy are linked to their child version nodes via the logical primary keys, to reduce the number of Input Output (“IO”) operations required to find an element in the multi-headed B+ index hierarchy,
determine, via a cloud-based computing environment, an update to a previous record in the geospatial database system data store,
insert a new record into the geospatial database system data store based on the update,
insert a new child version node into a new hierarchy of child version nodes for the new record such that the new hierarchy of child version nodes includes original, shared, and new child version nodes, and
insert a new head version node, representing the new record and new hierarchy of child version nodes, into the series of head version nodes; and
a remote user platform remote from the data indexing platform to access pre-configured tools that implement data analytics and Machine Learning (“ML”) associated with the cloud-based computing environment.

2. (canceled)

3. (canceled)

4. The system of claim 1, wherein each version captures a context of the relational versioned data at a specific point in time.

5. The system of claim 1, wherein the data indexing platform is further to traverse and cache the multi-headed B+ index.

6. The system of claim 1, wherein the data indexing platform records updates to the multi-headed B+ index as record level differences without storing duplicate nodes or records.

7. The system of claim 1, wherein the data indexing platform is able to maintain and access all records of the multi-headed B+ index that ever existed.

8. The system of claim 1, wherein the data indexing platform is further to provide a user with a versioned database view of the multi-headed B+ index via a set of tables and a tree of alternatives with epochs and checkpoints.

9. The system of claim 1, wherein a logical primary key is a hidden physical primary key.

10. A computerized data indexing method, comprising:
accessing, by a computer processor of a data indexing platform, a geospatial database system data store that contains records of relational versioned data and logical primary keys for interlinked electrical power grid network models;
maintaining a series of head version nodes linked to records of the geospatial database system data store, each head version node being associated with a directed acyclic graph forming a multi-headed B+ index hierarchy of child version nodes, including original and shared child version nodes, wherein the hierarchies end in original and shared records, and parent version nodes in the hierarchy are linked to their child version nodes via the logical primary keys, to reduce the number of Input Output (“IO”) operations required to find an element in the multi-headed B+ index hierarchy;
determining, via a cloud-based computing environment, an update to a previous record in the geospatial database system data store;
inserting a new record into the geospatial database system data store based on the update;
inserting a new child version node into a new hierarchy of child version nodes for the record such that the new hierarchy of child version nodes includes original, shared, and new child version nodes;
inserting a new head version node, representing the new record and new hierarchy of child version nodes, into the series of head version nodes;
communicating with a remote user platform remote from the data indexing platform to access pre-configured tools that implement data analytics and Machine Learning (“ML”) associated with the cloud-based computing environment; and
supporting data mobilization for field worker devices by creating consistent data extracts handed over to field worker devices that will be offline and synchronizing data back to the master data while applying version managed data synchronization when the field worker devices are back online.

11. (canceled)

12. (canceled)

13. The method of claim 10, wherein each version captures a context of the relational versioned data at a specific point in time.

14. The method of claim 10, wherein the data indexing platform is further to traverse and cache the multi-headed B+ index.

15. The method of claim 10, wherein the data indexing platform records updates to the multi-headed B+ index as record level differences without storing duplicate nodes or records.

16. The method of claim 10, wherein the data indexing platform is able to maintain and access all records of the multi-headed B+ index that ever existed.

17. The method of claim 10, wherein the data indexing platform is further to provide a user with a versioned database view of the multi-headed B+ index via a set of tables and a tree of alternatives with epochs and checkpoints.

18. The method of claim 10, wherein a logical primary key is a hidden physical primary key.

19. A non-transitory, computer-readable medium storing instructions that, when executed by a computer processor, cause the computer processor to perform a data indexing method, the method comprising:
accessing, by a computer processor of a data indexing platform, a geospatial database system data store that contains records of relational versioned data and logical primary keys for interlinked electrical power grid network models;
maintaining a series of head version nodes linked to records of the geospatial database system data store, each head version node being associated with a directed acyclic graph forming a multi-headed B+ index hierarchy of child version nodes, including original and shared child version nodes, wherein the hierarchies end in original and shared records, and parent version nodes in the hierarchy are linked to their child version nodes via the logical primary keys, to reduce the number of Input Output (“IO”) operations required to find an element in the multi-headed B+ index hierarchy;
determining, via a cloud-based computing environment, an update to a previous record in the geospatial database system data store;
inserting a new record into the geospatial database system data store based on the update;
inserting a new child version node into a new hierarchy of child version nodes for the record such that the new hierarchy of child version nodes includes original, shared, and new child version nodes;
inserting a new head version node, representing the new record and new hierarchy of child version nodes, into the series of head version nodes;
communicating with a remote user platform remote from the data indexing platform to access pre-configured tools that implement data analytics and Machine Learning (“ML”) associated with the cloud-based computing environment; and
supporting data mobilization for field worker devices by creating consistent data extracts handed over to field worker devices that will be offline and synchronizing data back to the master data while applying version managed data synchronization when the field worker devices are back online.

20. (canceled)
